(19) United States
(12) Patent Application Publication
(10) Pub. No.: US 2025/0199196 A1
(43) Pub. Date: Jun. 19, 2025

(54) SEDIMENT DATING CORRECTION METHOD AND SYSTEM

(71) Applicant: Second Institute of Oceanography, MNR, Hangzhou City (CN)

(72) Inventors: Xibin HAN, Hangzhou City (CN); Yi Zhang, Hangzhou City (CN); Yizhuo Wang, Hangzhou City (CN); Pengyun MA, Hangzhou City (CN); Rui Han, Hangzhou City (CN); Xiaohu Li, Hangzhou City (CN); Xiaowen Luo, Hangzhou City (CN); Ziyin Wu, Hangzhou City (CN); Wendong Wu, Hangzhou City (CN); Chen Sun, Hangzhou City (CN)

(73) Assignee: Second Institute of Oceanography, MNR, Hangzhou City (CN)

(21) Appl. No.: 18/768,078

(22) Filed: Jul. 10, 2024

(30) Foreign Application Priority Data
Dec. 19, 2023 (CN) 202311745543.1

(51) Int. Cl. G01V 9/00

(52) U.S. Cl. CPC G01V 9/00

(57) ABSTRACT

A sediment dating correction method and system are provided, relating to the technical field of sediment dating. By utilizing Isotope characteristics of ²¹⁰Pb, a sediment layer before ²¹⁰Pb reaches equilibrium is taken as a modern substance (namely, modern sediment horizon), AMS¹⁴C dating data of the modern sediment horizon and AMS¹⁴C dating data of sediment to be dated obtained by an AMS¹⁴C dating method are interpolated to obtain a correction value of an old carbon, so as to correct all ¹⁴C dating data to obtain a chronological framework of the sediment to be dated.

### CROSS-REFERENCE TO RELATED APPLICATION

This application claims the benefit and priority of Chinese Patent Application No. 202311745543.1, filed Dec. 19, 2023; the disclosure of which is incorporated herein by reference in its entirety.

### TECHNICAL FIELD

The present disclosure relates to the technical field of sediment dating, and in particular to a sediment dating correction method and system.

### BACKGROUND

Accurate chronological data is the basis and core of reconstructing past human activities, climate and environmental changes. The ¹⁴C dating of sediments is a method widely used in geology and archaeology. The age of samples is determined by measuring the content of radioactive carbon isotope ¹⁴C in sediments. However, the existing ¹⁴C dating method of sediments mainly depends on the existence of foraminifera. However, in some specific environments, such as mountains, lakes, glaciers and deserts, the sediments lack of the foraminifera are subjected to ¹⁴C dating with total carbon samples. Due to the mixing of “old carbon”, the age in the dating results tends to be older, and it is impossible to perform accurate age correction using the traditional ¹⁴C dating method.

### SUMMARY

In order to solve above problems in the conventional art, a sediment dating correction method and system are provided.

To achieve the objective above, the present disclosure employs the following technical solution:

A sediment dating correction method includes the following steps:
acquiring AMS¹⁴C dating data of each layer of sediment to be dated by an AMS¹⁴C dating method;
testing and analyzing isotopes of ²¹⁰Pb in a shallow surface layer of the sediment to be dated to obtain equilibrium of ²¹⁰Pb decaying with a depth of the sediment;
based on the equilibrium of ²¹⁰Pb decaying with the depth of the sediment, taking the shallow surface layer of the sediment to be dated as a modem sediment horizon to date AMS¹⁴C dating data of the shallow surface layer of the modem sediment horizon;
interpolating the AMS¹⁴C dating data of the shallow surface layer of the modern sediment horizon and AMS¹⁴C dating data of the shallow surface layer of the sediment to be dated obtained by the AMS¹⁴C dating method to obtain a correction value of “old carbon”;
subtracting the correction value of the “old carbon” from AMS¹⁴C dating data of each of other horizons except the shallow surface layer of the sediment to be dated to obtain a corrected AMS¹⁴C calendar year value of each layer of the sediment to be dated;
determining a deposition rate based on corrected AMS¹⁴C calendar year values of two adjacent layers in the sediment to be dated and a depth value between the two adjacent layers;
determining an AMS¹⁴C calendar year value of sediment between the two adjacent layers according to the deposition rate;
determining an AMS¹⁴C calendar year value of sediment outside the two adjacent layers according to the deposition rate; and
constructing a chronological framework according to the corrected AMS¹⁴C calendar year value of each layer of the sediment to be dated, the AMS¹⁴C calendar year value of the sediment between the two adjacent layers and the AMS¹⁴C calendar year value of the sediment outside the two adjacent layers, thus completing the dating of the sediment to be dated.

Alternatively, acquiring the AMS¹⁴C dating data of each layer of the sediment to be dated by the AMS¹⁴C dating method specifically includes the following steps:
acquiring a sediment sample at each layer of the sediment to be dated, and transforming acid-insoluble organic carbon in the sediment sample into graphite;
gasifying the graphite, separating carbon atoms from the gasified graphite by an accelerator, and receiving the separated carbon atoms by Faraday cups at different positions of an accelerator track, where the carbon atoms comprise ¹²C, ¹³C and ¹⁴C; and
determining a value of ¹⁴C/¹²C or a value of ¹⁴C/¹³C based on the received separated carbon atoms to achieve ¹⁴C measurement, and thus acquiring the AMS¹⁴C dating data of each layer of the sediment to be dated.

Alternatively, testing and analyzing the isotopes of ²¹⁰Pb in the shallow surface layer of the sediment to be dated to obtain the equilibrium of ²¹⁰Pb decaying with the depth of the sediment specifically includes the following steps:
taking the sediment to be dated with a set weight, grinding and sieving the sediment to be dated with a 100-mesh sieve to obtain sample powder;
filling the sample powder into a sample tube, and sealing and placing the sample tube for a set days; and
inserting an ORTEC high-purity germanium well-shaped probe into the sample tube filled with the sample powder for radioisotope measurement, analyzing ta rule that ²¹⁰Pb decays exponentially with an increase of a depth according to a radioactive decay rule, and obtaining the equilibrium of the ²¹⁰Pb decaying with the depth of sediment until a variation of a value of ²¹⁰Pb tends to be relatively stable.

Alternatively, an interpolation method is used to determine the AMS¹⁴C calendar year value of the sediment between the two adjacent layers according to the deposition rate.

Alternatively, an extrapolation method is used to determine the AMS¹⁴C calendar year value of the sediment outside the two adjacent layers according to the deposition rate.

Further, a sediment dating correction system is further provided. The system is used for implementing the sediment dating correction method above, and includes:
a first dating module, configured to acquire AMS¹⁴C dating data of each layer of sediment to be dated by an AMS¹⁴C dating method;
an equilibrium determination module, configured to test and analyze isotopes of ²¹⁰Pb in a shallow surface layer of the sediment to be dated to obtain equilibrium of ²¹⁰Pb decaying with a depth of the sediment;
a second dating module, configured to take the shallow surface layer of the sediment to be dated as a modern sediment horizon by using the equilibrium of ²¹⁰Pb decaying with the depth of the sediment, so as to date AMS¹⁴C dating data of the shallow surface layer of the sediment to be dated;
a correction value determination module, configured to interpolate the AMS¹⁴C dating data of the shallow surface layer of the sediment to be dated and AMS¹⁴C dating data of the shallow surface layer of the sediment to be dated obtained by the AMS¹⁴C dating method to obtain a correction value of “old carbon”;
a dating data correction module, configured to subtract the correction value of the “old carbon” from AMS¹⁴C dating data of each of other horizons except the shallow surface layer of the sediment to be dated to obtain a corrected AMS¹⁴C calendar year value of each layer of the sediment to be dated;
a deposition rate determination module, configured to determine a deposition rate based on corrected AMS¹⁴C calendar year values of two adjacent layers in the sediment to be dated and a depth value between the two adjacent layers;
a third dating module, configured to determine an AMS¹⁴C calendar year value of sediment between the two adjacent layers according to the deposition rate;
a fourth dating module, configured to determine an AMS¹⁴C calendar year value of sediment outside the two adjacent layers according to the deposition rate; and
a chronological framework construction module, configured to construct a chronological framework according to the corrected AMS¹⁴C calendar year value of each layer of the sediment to be dated, the AMS¹⁴C calendar year value of the sediment between the two adjacent layers and the AMS¹⁴C calendar year value of the sediment outside the two adjacent layers, thus completing the dating of the sediment to be dated.

According to specific embodiments of the present disclosure, the present disclosure has the following technical effects:

1. The sediment dating correction method provided by the present disclosure, when applied to the age correction of the ¹⁴C dating of sediment lack of the foraminifera, can fill the blank in the conventional art.

2. By analyzing the total carbon ¹⁴C dating data and ²¹⁰Pb isotope data of the sediment, the age of the sediment lack of the foraminifera can be accurately inferred, and the reliability and accuracy of ¹⁴C dating of the sediment are improved.

3. The method is simple and feasible, and does not require additional equipment and complicated experimental operations, thus reducing the cost and implementation difficulty of sediment dating.

### BRIEF DESCRIPTION OF THE DRAWINGS

To describe the technical solutions of the embodiments of the present disclosure or in the conventional art more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawing without creative efforts.

FIG. 1 is a flow diagram of a sediment dating correction method according to the present disclosure.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

An objective of the present disclosure is to provide a dating correction method and system suitable for sediment lack of foraminifera, which can accurately infer an age of the sediment lacking the foraminifera and improve reliability and accuracy of ¹⁴C dating of the sediment. In addition, no additional equipment and complicated experimental operation are required, and the cost and implementation difficulty of sediment dating can be reduced.

In order to make the objectives, features and advantages of the present disclosure more clearly, the present disclosure is further described in detail below with reference to the accompanying drawing and the embodiments.

According to the present disclosure, a “substitution” principle in TRIZ (Theory of Inventive Problem Solving) is utilized, and a traditional sediment ¹⁴C dating method relying on the foraminifera is replaced by analyzing a total carbon sample of the sediment and the isotope content of ²¹⁰Pb. This substitution idea is creative and can solve the problem that the traditional method cannot accurately date the sediment lack of the foraminifera. Meanwhile, the principle of “interpolation” is further combined, a relationship model between the isotope content and the age is established, and an accurate age correction of the sediment to be dated is achieved using an interpolation calculation method.

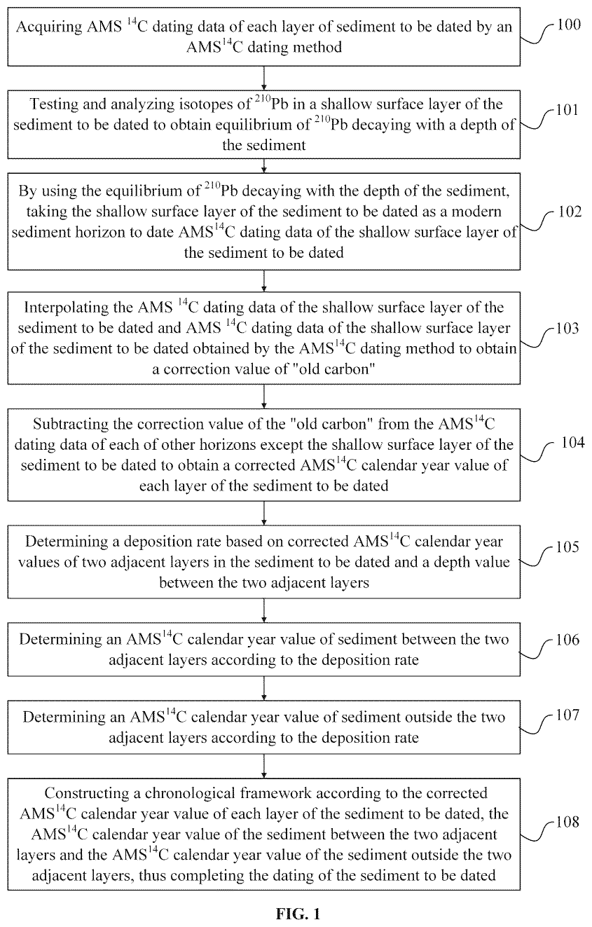

As shown FIG. 1, a sediment dating correction method according to the present disclosure includes the following steps:

Step 100: AMS¹⁴C dating data of each layer of sediment to be dated is acquired using an AMS¹⁴C dating method.

During an actual application, total carbon AMS¹⁴C dating experiments of columnar sediment can be carried out to obtain AMS¹⁴C dating data of each layer of the sediment to be dated, specifically as follows:

Acid-insoluble organic carbon in a sediment sample is transformed into graphite to be gasified and then pass through an accelerator for removing impurity particles, stripping electrons, and accelerating positrons, achieving separation of carbon atoms such as ¹²C, ¹³C and ¹⁴C; the carbon atoms are received by Faraday cups at different positions of an accelerator track; and then a value of ¹⁴C/¹²C or a value of ¹⁴C/¹³C is calculated to achieve ¹⁴C measurement, thus acquiring the AMS¹⁴C dating data of the sediment to be dated.

Step 101: isotopes of ²¹⁰Pb in a shallow surface layer of the sediment to be dated are tested and analyzed to obtain equilibrium of ²¹⁰Pb decaying with a depth of the sediment.

During an actual application, the isotopes of ²¹⁰Pb at the shallow surface layer of the columnar sediment are tested and analyzed through experiments to obtain the equilibrium of ²¹⁰Pb decaying with the depth of the sediment. The experiments are conducted according to the national standard of People's Republic of China (PRC), Determination of radionuclide in marine sediment—Gamma spectrometry (GB/T 30738-2014), specifically as follows:

Dry sediment with a set weight (for example, 10 g) is ground, and screened with a 100-mesh sieve to remove plant roots, and then is filled and sealed in a sample tube. The sample tube is placed for set days (for example, 20 days). An ORTEC high-purity germanium well-shaped probe (GWL-120-15N) is used for radioisotope measurement. The measurement of each sample generally lasts for 1-3 days, a specific activity of a total ²¹⁰Pb is a peak area at 46.5 keV (2¹⁰Pb) energy, a specific activity of a background ²¹⁰Pb is a peak area at 351 keV (the daughters of ²¹⁴Pb and ²²⁶Ra) energy, and a specific activity of an excess ²¹⁰Pb is a difference between the specific activity of the total ²¹⁰Pb and the specific activity of the background ²¹⁰Pb. A rule that ²¹⁰Pb decays exponentially with an increase of depth according to radioactive decay rule is analyzed. ²¹⁰Pb belongs to uranium-series decaying nuclides, with half-life of 22.3a. After about seven half-lives, an intensity of ²¹⁰Pb nuclide commonly used in the sediment dating decays to about 1% of an initial value, which is difficult to be accurately detected by an instrument, so an upper limit of ²¹⁰Pb dating is about 150a. A total uranium-series decay nuclide ²¹⁰Pbₜₒₜₐₗ in the sediment is composed of two parts, one is from ²¹⁰Pb from a natural decay of ²²⁶Ra accumulated in the sediment, which is called compensated ²¹⁰Pb, and the other part is from deposited ²¹⁰Pb, which is called excess ²¹⁰Pb, i.e., ²¹⁰Pbₑₓ. Both ²²⁶Ra and ²¹⁰Pb belong to ²³⁸U decay series nuclides, so ²²⁶Ra and ²¹⁰Pb can be regarded as a pair of parent and daughter. Assuming that ²²⁶Ra and ²¹⁰Pb have no other inputs and outputs, after decay of these two nuclides reaches equilibrium at a certain depth, the excess ²¹⁰Pb will become a relatively stable value, and a part above this depth can be regarded as having properties of modern deposition.

Step 102: by using the equilibrium of ²¹⁰Pb decaying with the depth of the sediment, the shallow surface layer of the sediment to be dated is taken as a modern sediment horizon to date AMS¹⁴C dating data of the shallow surface layer of the sediment to be dated.

Step 103: the AMS¹⁴C dating data of the shallow surface layer of the sediment to be dated and AMS¹⁴C dating data of the shallow surface layer of the sediment to be dated obtained by the AMS¹⁴C dating method are interpolated to obtain a correction value of “old carbon”.

Step 104: the correction value of the “old carbon” is subtracted from the AMS¹⁴C dating data of each of other horizons except the shallow surface layer of the sediment to be dated to obtain a corrected AMS¹⁴C calendar year value of each layer of the sediment to be dated.

In Step 102 to Step 104, the modern sediment horizon (Ocal BP) is determined using the equilibrium of shallow surface layer sediment ²¹⁰Pb decaying with the depth in Step 101, so as to date the AMS¹⁴C dating data of the modern sediment horizon, and the correction value of the “old carbon” is obtained according to an interpolation of the AMS¹⁴C dating data dated in Step 100 and Step 102. The correction is achieved by subtracting the correction value of the “old carbon” from the AMS¹⁴C values of other horizons, and then the corrected AMS¹⁴C calendar year value of each layer of the sediment to be dated is obtained.

Step 105: a deposition rate is determined based on corrected AMS¹⁴C calendar year values of two adjacent layers in the sediment to be dated and a depth value between the two adjacent layers.

Step 106: an AMS¹⁴C calendar year value of sediment between the two adjacent layers is determined according to the deposition rate. According to the deposition rate, a part between two horizons is interpolated to calculate a corresponding AMS¹⁴C calendar year value thereof.

Step 107: an AMS¹⁴C calendar year value of sediment outside the two adjacent layers is determined according to the deposition rate. The part outside the two horizons is extrapolated to calculate a corresponding AMS¹⁴C calendar year value thereof, so as to achieve an interpolation and data extension of the calendar year values for a subsequent establishment of a chronological framework.

Step 108: the chronological framework is constructed according to the corrected AMS¹⁴C calendar year value of each layer of the sediment to be dated, the AMS¹⁴C calendar year value of the sediment between the two adjacent layers and the AMS¹⁴C calendar year value of the sediment outside the two adjacent layers, thus completing the dating of the sediment to be dated.

Based on above description, based on the fact that ²¹⁰Pb widely exists in the natural environment and has a half-life of 22.3a, the ²¹⁰Pb formed earlier decays exponentially with the increase of the depth according to the radioactive decay rule, and reaches the equilibrium at a certain depth, and thus it is considered that ²¹⁰Pb above the depth is the sediment within 150a. Compared with the half-life of 5730a in ¹⁴C dating and its errors of tens to hundreds of years, the sediment horizon before ²¹⁰Pb reaches equilibrium can be used as modern substance, and the age value is set as 0 Cal a BP. Therefore, the value of ¹⁴C dating of this horizon is determined as an error value of the “old carbon”, so as to correct all ¹⁴C dating data of this station, and then to establish the chronological framework of the calendar year.

According to the present disclosure, the “substitution” principle in TRIZ is utilized, and the traditional sediment ¹⁴C dating method relying on the foraminifera is replaced by analyzing a total carbon sample of the sediment and the isotope content of ²¹⁰Pb. This substitution idea is creative and can solve the problem that traditional method cannot accurately date the sediment lack of the foraminifera. Meanwhile, the principle of “interpolation” is further combined, a relationship model between isotope content and the age is established, and the accurate age correction of the sediment to be dated is achieved using the interpolation calculation method.

Further, a sediment dating correction system is further provided. The system is used for implementing the sediment dating correction method above. The system includes a first dating module, an equilibrium determination module, a second dating module, a correction value determination module, a dating data correction module, a deposition rate determination module, a third dating module, a fourth dating module, and a chronological framework construction module.

The first dating module is configured to acquire AMS¹⁴C dating data of each layer of sediment to be dated by an AMS¹⁴C dating method.

The equilibrium determination module is configured to test and analyze isotopes of ²¹⁰Pb in a shallow surface layer of the sediment to be dated to obtain equilibrium of ²¹⁰Pb decaying with a depth of the sediment.

The second dating module is configured to take the shallow surface layer of the sediment to be dated as a modern sediment horizon by using the equilibrium of ²¹⁰Pb decaying with the depth of the sediment, so as to date AMS¹⁴C dating data of the shallow surface layer of the modern sediment horizon.

The correction value determination module is configured to interpolate the AMS¹⁴C dating data of the shallow surface layer of the modern sediment horizon and AMS¹⁴C dating data of the shallow surface layer of the sediment to be dated obtained by the AMS¹⁴C dating method to obtain a correction value of “old carbon”.

The dating data correction module is configured to subtract the correction value of the “old carbon” from the AMS¹⁴C dating data of each of other horizons except the shallow surface layer of the sediment to be dated to obtain a corrected AMS¹⁴C calendar year value of each layer of the sediment to be dated.

The deposition rate determination module is configured to determine a deposition rate based on corrected AMS¹⁴C calendar year values of two adjacent layers in the sediment to be dated and a depth value between the two adjacent layers.

The third dating module is configured to determine an AMS¹⁴C calendar year value of sediment between the two adjacent layers according to the deposition rate.

The fourth dating module is configured to determine an AMS¹⁴C calendar year value of sediment outside the two adjacent layers according to the deposition rate.

The chronological framework construction module is configured to construct a chronological framework according to the corrected AMS¹⁴C calendar year value of each layer of the sediment to be dated, the AMS¹⁴C calendar year value of the sediment between the two adjacent layers and the AMS¹⁴C calendar year value of the sediment outside the two adjacent layers, thus completing the dating of the sediment to be dated.

Various embodiments in this specification are described in a progressive way, and each embodiment focuses on the differences from other embodiments, so it is only necessary to refer to the same and similar parts between each embodiment. Since the system disclosed by the embodiments corresponds to the method disclosed by the embodiments, the description is relatively simple, and the reference is made to the descriptions in the method for related parts.

Specific examples are used here for illustration of the principles and implementation methods of the present disclosure. The description of the embodiments is merely used to help illustrate the method and its core principles of the present disclosure. In addition, those of ordinary skill in the art can make changes in terms of specific embodiments and scope of application in accordance with the teachings of the present disclosure. In conclusion, the content of this specification shall not be construed as a limitation to the present disclosure.

What is claimed is:

1. A sediment dating correction method, comprising:
acquiring AMS¹⁴C dating data of each layer of sediment to be dated by an AMS¹⁴C dating method;
testing and analyzing isotopes of ²¹⁰Pb in a shallow surface layer of the sediment to be dated to obtain equilibrium of ²¹⁰Pb decaying with a depth of the sediment;
based on the equilibrium of ²¹⁰Pb decaying with the depth of the sediment, taking the shallow surface layer of the sediment to be dated as a modern sediment horizon to date AMS¹⁴C dating data of the modern sediment horizon;
interpolating the AMS¹⁴C dating data of the shallow surface layer of the sediment to be dated and AMS¹⁴C dating data of the shallow surface layer of the sediment to be dated obtained by the AMS¹⁴C dating method to obtain a correction value of an old carbon;
subtracting the correction value of the old carbon from AMS¹⁴C dating data of each of other horizons except the shallow surface layer of the sediment to be dated to obtain a corrected AMS¹⁴C calendar year value of each layer of the sediment to be dated;
determining a deposition rate based on corrected AMS¹⁴C calendar year values of two adjacent layers in the sediment to be dated and a depth value between the two adjacent layers;
determining an AMS¹⁴C calendar year value of sediment between the two adjacent layers according to the deposition rate;
determining an AMS¹⁴C calendar year value of sediment outside the two adjacent layers according to the deposition rate; and
constructing a chronological framework according to the corrected AMS¹⁴C calendar year value of each layer of the sediment to be dated, the AMS¹⁴C calendar year value of the sediment between the two adjacent layers and the AMS¹⁴C calendar year value of the sediment outside the two adjacent layers, thus completing the dating of the sediment to be dated.

2. The sediment dating correction method according to claim 1, wherein acquiring the AMS¹⁴C dating data of each layer of the sediment to be dated by the AMS¹⁴C dating method comprises:
acquiring a sediment sample at each layer of the sediment to be dated, and transforming acid-insoluble organic carbon in the sediment sample into graphite;
gasifying the graphite, separating carbon atoms from the gasified graphite by an accelerator, and receiving the separated carbon atoms by Faraday cups at different positions of an accelerator track, wherein the carbon atoms comprise ¹²C, ¹³C and ¹⁴C; and
determining a value of ¹⁴C/¹²C or a value of ¹⁴C/¹³C based on the received separated carbon atoms to achieve ¹⁴C measurement, and thus acquiring the AMS¹⁴C dating data of each layer of the sediment to be dated.

3. The sediment dating correction method according to claim 1, wherein testing and analyzing the isotopes of ²¹⁰Pb in the shallow surface layer of the sediment to be dated to obtain the equilibrium of ²¹⁰Pb decaying with the depth of the sediment comprises:
taking the sediment to be dated with a set weight, grinding and sieving the sediment to be dated with a 100-mesh sieve to obtain sample powder;
filling the sample powder into a sample tube, and sealing and placing the sample tube for set days; and
inserting an ORTEC high-purity germanium well-shaped probe into the sample tube filled with the sample powder for radioisotope measurement, analyzing a rule that ²¹⁰Pb decays exponentially with an increase of a depth according to a radioactive decay rule, and obtaining the equilibrium of the ²¹⁰Pb decaying with the depth of sediment until a variation of a value of ²¹⁰Pb tends to be relatively stable.

4. The sediment dating correction method according to claim 1, wherein an interpolation method is used to determine the AMS¹⁴C calendar year value of the sediment between the two adjacent layers according to the deposition rate.

5. The sediment dating correction method according to claim 1, wherein an extrapolation method is used to determine the AMS¹⁴C calendar year value of the sediment outside the two adjacent layers according to the deposition rate.

6. A sediment dating correction system, wherein the system is used for implementing the sediment dating correction method according to claim 1, and comprises:
a first dating module, configured to acquire AMS¹⁴C dating data of each layer of sediment to be dated by an AMS¹⁴C dating method;
an equilibrium determination module, configured to test and analyze isotopes of ²¹⁰Pb in a shallow surface layer of the sediment to be dated to obtain equilibrium of ²¹⁰Pb decaying with a depth of the sediment;
a second dating module, configured to take the shallow surface layer of the sediment to be dated as a modern sediment horizon by using the equilibrium of ²¹⁰Pb decaying with the depth of the sediment, so as to date AMS¹⁴C dating data of the shallow surface layer of the sediment to be dated;
a correction value determination module, configured to interpolate the AMS¹⁴C dating data of the shallow surface layer of the sediment to be dated and AMS¹⁴C dating data of the shallow surface layer of the sediment to be dated obtained by the AMS¹⁴C dating method to obtain a correction value of an old carbon;
a dating data correction module, configured to subtract the correction value of the old carbon from AMS¹⁴C dating data of each of other horizons except the shallow surface layer of the sediment to be dated to obtain a corrected AMS¹⁴C calendar year value of each layer of the sediment to be dated;
a deposition rate determination module, configured to determine a deposition rate based on corrected AMS¹⁴C calendar year values of two adjacent layers in the sediment to be dated and a depth value between the two adjacent layers;
a third dating module, configured to determine an AMS¹⁴C calendar year value of sediment between the two adjacent layers according to the deposition rate;
a fourth dating module, configured to determine an AMS¹⁴C calendar year value of sediment outside the two adjacent layers according to the deposition rate; and
a chronological framework construction module, configured to construct a chronological framework according to the corrected AMS¹⁴C calendar year value of each layer of the sediment to be dated, the AMS¹⁴C calendar year value of the sediment between the two adjacent layers and the AMS¹⁴C calendar year value of the sediment outside the two adjacent layers, thus completing the dating of the sediment to be dated.
